(19) United States
(12) Patent Application Publication
(10) Pub. No.: US 2025/0025830 A1
(43) Pub. Date: Jan. 23, 2025

(54) POLY(IONIC LIQUID)S COMPOSITE FOR ABSORPTION AND SEPARATION

(71) Applicant: W. L. Gore & Associates, Inc., Newark, DE (US)

(72) Inventors: Shaofeng Ran, Kennett Square, PA (US); Gregory J. Shafer, Oxford, PA (US)

(21) Appl. No.: 18/711,329

(22) PCT Filed: Nov. 14, 2022
(86) PCT No.: PCT/US2022/049798

§ 371 Date: May 17, 2024

Related U.S. Application Data
(60) Provisional application No. 63/281,235, filed on Nov. 19, 2021.

(51) Int. Cl. B01D 53/22; B01D 53/14; B01D 69/12; B01D 69/14; B01D 71/36

(52) U.S. Cl. CPC B01D 53/228; B01D 53/1475; B01D 53/1493; B01D 69/1213; B01D 69/144; B01D 71/36; B01D 2252/30; B01D 2257/504

(57) ABSTRACT

Provided herein are composite materials having an expanded porous membrane and a poly(ionic liquids)(PILs) which exhibit superior performance properties including high CO2 absorption, CO₂ permeability and CO₂/N₂ selectivity in combination with desirable mechanical properties such as being thin, strong, moisture and temperature resistant, and having flexibility, strength, and durability, laminates and articles including the composites, and processes for manufacture of the composites.

### CROSS-REFERENCE TO RELATED APPLICATION

This application is a national phase application of PCT Application No. PCT/US2022/049798, internationally filed on Nov. 14, 2022, which claims the benefit of Provisional Application No. 63/281,235, filed Nov. 19, 2021, which are incorporated herein by reference in their entireties for all purposes.

### FIELD

The present disclosure relates generally to composites material containing an expanded porous membrane and a poly(ionic liquid)s (PILs) having superior performance properties including high CO₂ absorption, high CO₂ permeability and CO₂/N₂ selectivity in combination with desirable mechanical properties (such as flexibility, strength, and durability), laminates and articles including the composites, and processes for manufacture of said composites.

### BACKGROUND

Ionic liquids are known as materials composed of cations and anions and present as liquids under normal temperature (<100° C.) and ambient pressure, and have attracted attention for their specific properties different from known solvents, such as high thermal stability, high electrochemical stability, and low volatility. Generally, an ionic liquid can be adjusted to have various characteristics by appropriately selecting and combining cationic species and anionic species. Ionic liquids are under consideration to be used in various applications such as electrochemical devices, separation applications and reaction solvents.

Polymerized ionic liquids or poly(ionic liquid)s (PILs) is the polymeric form of ionic liquids. Generally, ionic liquids are difficult to immobilize, and PILs membranes obtained directly from poly(ionic liquid)s, for example, via solvent casting are brittle, are difficult to handle and may exhibit low CO₂ permeability. And while it is possible to impregnate ionic liquid monomers into a porous polymer membrane support, these structures tend to fail at increasing pressures, for example beyond 1-2 atmospheres, resulting in the leaking or blowing out of the ionic liquids.

Carbon dioxide has been identified as one of the major greenhouse gases, and it has been widely accepted that CO₂ emissions may have an effect on the ozone layer of the earth's atmosphere, depending on the atmospheric layer the CO₂ accumulates in and on the latitude. It is believed that the excessive accumulation of CO₂ in the atmosphere contributes to global warming. As a result, and with the input of governmental agencies, there has been a drive both environmentally and commercially to capture CO₂ from gas stream sources, such as power plant flue gases, and subsequent utilization or underground sequestration. A known method is to capture of CO₂ with amine solutions. However, the CO₂ captured with amine solutions may form carbamates or carboxylates which although can be reversed and reused undergo significant thermal or oxidative degradation making their use less attractive.

Similarly, various polymeric membranes and in particular CO₂ selective membranes useful to separate CO₂ from a mixture gas by selectively permeating CO₂ have been developed. However, polymeric membranes physically permeate CO₂ based on solution diffusion mechanism, and thus, there is a limitation of the improvements in CO₂ permeability and CO₂/N₂ selectivity that can be achieved. Moreover, flue gases separation applications are considered harsh to most of the polymer membranes such as high temperatures, high acidity, high moisture, etc.

Expanded porous membranes are known in art. For example, an expanded polytetrafluoroethylene (ePTFE) film may be produced by a process taught in U.S. Pat. No. 3,953,566, to Gore. The porous ePTFE formed by this process has a microstructure of nodes interconnected by fibrils, demonstrates higher strength than unexpanded PTFE, and retains the chemical inertness and wide useful temperature range of unexpanded PTFE. However, such an expanded PTFE membrane is porous and therefore cannot be used alone as a selective membrane.

Thus, there exists a need in the art for a composite material that demonstrates improved performance having a combination of desirable performance properties, including having high CO₂ capture and separation, high CO₂/N₂ selectivity while at the same time having desirable mechanical properties, such as being thin, strong, moisture, temperature and chemical resistant.

### SUMMARY

Provided herein are composite materials having an expanded porous membrane and a poly(ionic liquid)s(PILs) which exhibit superior performance properties including high CO₂ absorption, permeability and CO₂/N₂ selectivity in combination with desirable mechanical properties such as being thin, strong, moisture and temperature resistant, and having flexibility, strength, and durability, laminates and articles including the composites, and processes for manufacture of the composites.

Various aspects of the concepts addressed herein provide for a composite having excellent CO₂ absorption and separation properties, without compromising existing mechanical, chemical, and thermal characteristics of traditional porous membranes, sheets or films. In some examples, the composites are made in unusually, or surprisingly thin form, but in other examples the composites may be of substantial thickness.

According to a first embodiment (“Embodiment 1”), a composite material includes: an expanded porous membrane having a thickness, where the expanded porous membrane has a microstructure of fibrils, and optionally nodes interconnecting the fibrils, and a void volume providing pores; and a poly(ionic liquid)s polymer (PILs).

According to a second embodiment further to Embodiment 1 (“Embodiment 2”), the PILs forms a coating on the nodes and fibrils of the expanded porous membrane.

According to a third embodiment further to any preceding Embodiment (“Embodiment 3”), the PILs fills the entirety of the void volume of the expanded porous membrane.

According to a fourth embodiment further to any preceding Embodiment (“Embodiment 4”), the PILs fills at least a portion of the void volume of the expanded porous membrane.

According to a fifth embodiment further to any preceding Embodiment (“Embodiment 5”), the PILs fills a majority of the void volume of the expanded porous membrane.

According to a sixth embodiment further to any preceding Embodiment (“Embodiment 6”), the expanded porous membrane includes one or more of the following: polytetrafluoroethylene (PTFE), ultra high molecular weight polyethylene (UHMWPE), tetrafluoroethylene (TFE) copolymers, polylactic acid (PLA), polyparaxylylene (PPX), polyvinylidene difluoride (PVDF), vinylidene difluoride (VDF) copolymers, or poly(ethylene tetrafluoroethylene) (ETFE).

According to a seventh embodiment further to any preceding Embodiment (“Embodiment 7”), the expanded porous membrane includes expanded polytetrafluoroethylene (ePTFE) or expanded ultra high molecular weight polyethylene (eUHMWPE).

According to an eighth embodiment further to any preceding Embodiment (“Embodiment 8”), the PILs includes a cation selected from the group consisting of ammonium, imidazolium, pyridinium, phosphonium, and pyrrolidone, and a counter anion selected from the group consisting of halide, bistrifluoromethylsulfonimide, tetrafluoroborate, and acetate.

According to a ninth embodiment further to any preceding Embodiment (“Embodiment 9”), the PILs is selected from the group consisting of poly (diallyldimethylammonium) bis(trifluoromethane)sulfonimide(PDDMATFSI), poly (diallyldimethylammonium) chloride(PDDMACI), poly (diallyldimethylammonium) tetrafluoroborate(PDDMABF4), poly ((vinylbenzyl) trimethylammonium) bis(trifluoromethane)sulfonimide(PVBTMATFSI), poly ((vinylbenzyl) trimethylammonium) chloride, (PVBTMACI), poly ((vinylbenzyl) trimethylammonium) tetrafluoroborate (PVBTMABF4), and poly ((vinylbenzyl) trimethylammonium) acetate (PVBTMAOAc).

According to a tenth embodiment further to any preceding Embodiment (“Embodiment 10”), the composite material has a porosity from greater than about 20% to about 99%.

According to an eleventh embodiment further to any preceding Embodiment (“Embodiment 11”), the composite material has a porosity of less than 20%.

According to a twelfth embodiment further to any preceding Embodiment (“Embodiment 12”), the further including at least one active agent.

According to a thirteenth embodiment further to Embodiment 12 (“Embodiment 13”), the active agent is covalently or non-covalently bound to the PILs.

According to a fourteenth embodiment further to Embodiment 12 or 13 (“Embodiment 14”), the active agent is selected from the group consisting of inorganic particles, inorganic nanoparticles, metals, metal oxides, metal salts, carbon nanotubes (CNTs), fullerenes, graphene, catalytic particles, polyoxometalates (POMs), metal organic frameworks (MOFs), additional polymers, silica, quantum dots, ionic liquids, biologically active molecules, and any combination thereof.

According to a fifteenth embodiment further Embodiment 14 (“Embodiment 15”), the biologically active molecule is a polypeptide, protein, enzyme catalyst, enzyme, enzyme extract, whole cell, antibody, lipid, nucleic acid molecule, carbohydrate, or any combination thereof.

According to a sixteenth embodiment further to any preceding Embodiment (“Embodiment 16”), the weight percent of the poly(ionic liquid)s polymer relative to the total weight of the composite material ranges from about 1 wt % to about 90 wt %.

According to a seventeenth embodiment further to any preceding Embodiment (“Embodiment 17”), the composite material further includes a support layer.

According to an eighteenth embodiment further to any preceding Embodiment (“Embodiment 18”), the composite material has a CO₂ absorption capacity from about 0.3 mmol CO₂/g PILs to about 1.2 mmol CO₂/g PILs.

According to a nineteenth embodiment further to any preceding Embodiment (“Embodiment 19”), the composite material has a CO₂ permeability of more than 1.0 barrer.

According to a twentieth embodiment further to any preceding Embodiment (“Embodiment 20”), the composite material has a N₂ permeability of less than 1.5 barrer.

According to a twenty-first embodiment further to any preceding Embodiment (“Embodiment 21”), the composite material has a selectivity calculated as CO₂ permeability/N₂ permeability of greater than 8.0.

According to a twenty-second embodiment further to any preceding Embodiment (“Embodiment 22”), provided is a laminate including the composite material of any preceding embodiment.

According to a twenty-third embodiment further to any preceding Embodiment (“Embodiment 23”), provided is an article including the composite material of embodiment 1-20 or the laminate of embodiment 22.

According to a twenty-fourth embodiment further to any preceding Embodiment (“Embodiment 24”), a method of separating a gas from a mixture includes providing the composite material, laminate or article of any preceding embodiment and separating the gas from the mixture by contacting the mixture and the composite material, laminate or article.

According to a twenty-fifth embodiment further to any preceding Embodiment (“Embodiment 25”), the gas is carbon dioxide.

According to a twenty-sixth embodiment further to any preceding Embodiment (“Embodiment 26”), the method includes:
(a) dissolving a solid poly(ionic liquid)s polymer in a solvent to form a poly(ionic liquid)s polymer solution;
(b) applying the poly(ionic liquid)s polymer solution to a porous polymer membrane having a void volume providing pores and a microstructure of nodes interconnected by fibrils or only fibrils; and
(c) removing the solvent after applying the poly(ionic liquid)s polymer solution to the porous polymer membrane.

According to a twenty-seventh embodiment further to any preceding Embodiment (“Embodiment 27”), the poly(ionic liquid)s polymer is partially or fully imbibed into the void volume of the microstructure of the porous polymer membrane.

According to a twenty-eighth embodiment further to Embodiment 26 or 27 (“Embodiment 28”), further including (d) expanding the composite material after step (b) and/or after step (c).

According to a twenty-ninth embodiment further to Embodiment 26 to 28 (“Embodiment 29”), further including (f) compressing the composite material after step (b), step (c), and/or step (d).

According to a 30th embodiment further to any preceding Embodiment (“Embodiment 30”), a method to form a composite material includes (a) providing (i) a poly(ionic liquid)s polymer solution; and (ii) an expanded porous membrane having a first side and a second side; where the expanded porous membrane has a void volume providing pores and a microstructure of fibrils, and optionally nodes interconnecting the fibrils; and (b) depositing the poly(ionic liquid)s polymer solution on at least one side of the expanded porous membrane whereby the composite material is formed; (c) optionally subjecting the composite material of step (b) to one or more steps of heating, stretching, compacting or any combination thereof.

The foregoing Embodiments are just that and should not be read to limit or otherwise narrow the scope of any of the inventive concepts otherwise provided by the instant disclosure. While multiple examples are disclosed, still other embodiments will become apparent to those skilled in the art from the following detailed description, which shows and describes illustrative examples. Accordingly, the drawings and detailed description are to be regarded as illustrative in nature rather than restrictive in nature.

### BRIEF DESCRIPTION OF THE DRAWINGS

The accompanying drawings are included to provide a further understanding of the disclosure and are incorporated in and constitute a part of this specification, illustrate embodiments, and together with the description serve to explain the principles of the disclosure.

FIG. 1 is a SEM micrograph of the cross sectioned sample of a PILs fully imbibed ePTFE membrane containing a monolithic top coating in accordance with an embodiment.

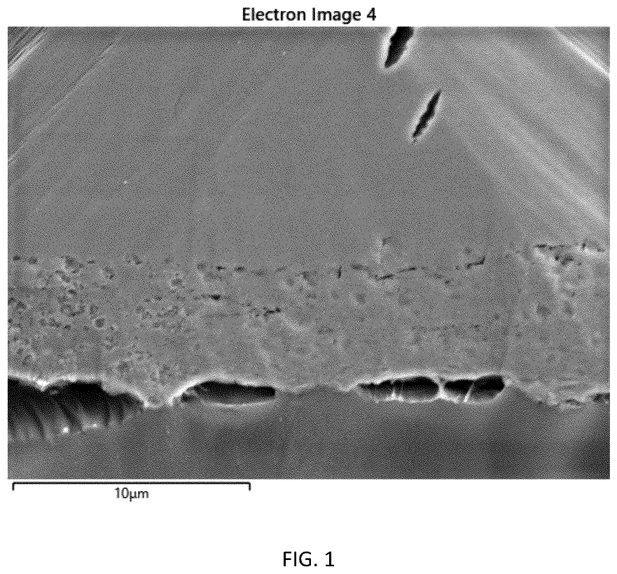

FIG. 2 is a SEM micrograph of the cross section of a PILs coated sample analyzed by EDS (energy dispersive X-ray spectroscopy) image showing the PILs coating on the notes and fibrils of the ePTFE membrane.

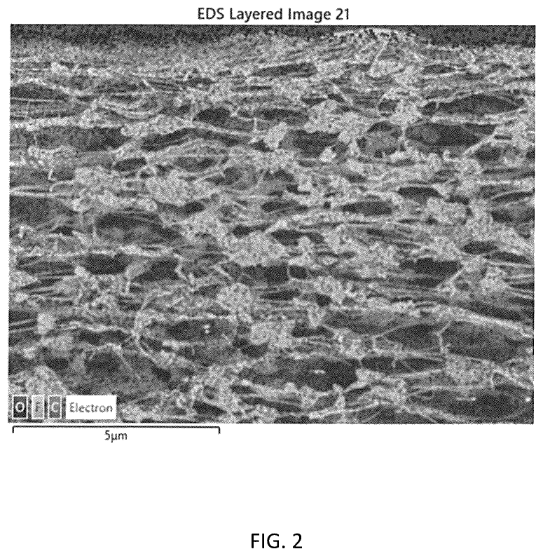

FIGS. 3A and 3B are graphical images of the kinetic data and the temperature swing sorption cycling measured in Example 6. FIG. 3A represents the data collected for an ePTFE poly ((vinylbenzyl) trimethylammonium) acetate (PVBTMAOAc) membrane composite while FIG. 3B represents the data collected for the PVBTMAOAc powder.

### DETAILED DESCRIPTION

### Definitions and Terminology

This disclosure is not meant to be read in a restrictive manner. For example, the terminology used in the application should be read broadly in the context of the meaning those in the field would attribute such terminology.

With respect to terminology of inexactitude, the terms “about” and “approximately” may be used, interchangeably, to refer to a measurement that includes the stated measurement and that also includes any measurements that are reasonably close to the stated measurement. Measurements that are reasonably close to the stated measurement deviate from the stated measurement by a reasonably small amount as understood and readily ascertained by individuals having ordinary skill in the relevant arts. Such deviations may be attributable to measurement error, differences in measurement and/or manufacturing equipment calibration, human error in reading and/or setting measurements, minor adjustments made to optimize performance and/or structural parameters in view of differences in measurements associated with other components, particular implementation scenarios, imprecise adjustment and/or manipulation of objects by a person or machine, and/or the like, for example. In the event it is determined that individuals having ordinary skill in the relevant arts would not readily ascertain values for such reasonably small differences, the terms “about” and “approximately” can be understood to mean plus or minus 10% of the stated value.

Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint. When ranges are listed in the specification and in the claims, it is understood that all the numbers including decimals within the range are included whether specifically disclosed. For example, if the range is from 1 to 10, the range would include every number within the range, such as 1; 1.1; 1.2; 1.3; 1.4; 1.5; 1.6; 1.7; 1.8; 1.9; 2; 2.1; 2.2; 2.3; 2.4; 2.5; 2.6; 2.7; 2.8; 2.9; 3; 3.1; 3.2; 3.3; 3.4; 3.5; 3.6; 3.7; 3.8; 3.9; 4; 4.1; 4.2; 4.3; 4.4; 4.5; 4.6; 4.7; 4.8; 4.9; 5; 5.1; 5.2; 5.3; 5.4; 5.5; 5.6; 5.7; 5.8; 5.9; 6; 6.1; 6.2; 6.3; 6.4; 6.5; 6.6; 6.7; 6.8; 6.9; 7; 7.1; 7.2; 7.3; 7.4; 7.5; 7.6; 7.7; 7.8; 7.9; 8; 8.1; 8.2; 8.3; 8.4; 8.5; 8.6; 8.7; 8.8; 8.9; 9; 9.1; 9.2; 9.3; 9.4; 9.5; 9.6; 9.7; 9.8; 9.9 and 10. It is further understood that “0” is not included in the range of less than or equal to unless specifically called out, and likewise that “100” is not included in the range of greater than or equal to unless specifically called out.

As used in this application, the term “pore size” means the average size of the pores in porous membranes. Pore size can be characterized by bubble point, mean flow pore size, or water entry pressure, as described in more detail herein.

As used herein, the singular forms “a”, “an”, and “the” include plural reference unless the context clearly dictates otherwise. The term “on” as used herein is meant to denote that when an element is “on” another element, it can be directly on the other element or intervening elements may also be present. It is to be appreciated that the terms “fine powder” and “powder” may be used interchangeably herein. Also, the terms “ePTFE membrane(s)” and “membrane(s)” may be used interchangeably herein. Further, in this application, the term “ePTFE membrane” is meant to include a single layer or multiple layers of ePTFE membrane(s). It is to be understood that the machine direction and the longitudinal direction are the same and may be interchangeably used herein. In addition, the terms “microporous ePTFE membrane” and “ePTFE membrane” may be used interchangeably herein.

The PTFE starting material may be a PTFE homopolymer, a modified PTFE homopolymer, or a blend of PTFE homopolymers. In another embodiment, the PTFE starting material may be a blend of a PTFE homopolymer and a PTFE copolymer in which comonomer units are not present in amounts which cause the copolymer to lose the non-melt processible characteristics of a pure homopolymer PTFE. Examples of suitable comonomers in the PTFE copolymer include, but are not limited to, olefins such as ethylene and propylene; halogenated olefins such as hexafluoropropylene (HFP), vinylidene fluoride (VDF), and chlorofluoroethylene (CFE); perfluoroalkyl vinyl ether (PPVE), and perfluoro sulfonyl vinyl ether (PSVE). In yet another embodiment, the first and/or second PTFE membrane may be formed from a blend of high molecular weight PTFE homopolymer and a lower molecular weight modified PTFE polymer.

### DESCRIPTION OF VARIOUS EMBODIMENTS

Persons skilled in the art will readily appreciate that various aspects of the present disclosure can be realized by any number of methods and apparatuses configured to perform the intended functions. It should also be noted that the accompanying drawing figures referred to herein are not necessarily drawn to scale, but may be exaggerated to illustrate various aspects of the present disclosure, and in that regard, the drawing figures should not be construed as limiting.

Various concepts addressed herein relate to composites materials including an expanded porous membrane and a poly(ionic liquid)s. This description also provides for processes for making composite materials. The composite materials may have superior performance properties including one or more of very high CO₂ absorption capacity, high CO₂/N₂ and CO₂/CH₄ selectivity in combination with desirable mechanical properties such as one or more of relatively high flexibility, strength, and durability, for example.

A composite material according to one embodiment includes a porous membrane and a poly(ionic liquid)s polymer (PILs). It should be readily appreciated that multiple types of porous membranes and multiple types of PILs can be combined while within the spirit of the present embodiments. The porous membrane of the present embodiments may have any suitable microstructure for achieving the desired composite material performance. For examples, the porous membrane may have a microstructure of substantially only fibrils, or, optionally, nodes interconnection the fibrils, and a void volume providing pores. The porous PTFE membranes may be prepared using methodology known to those skilled in the art, such as that described in U.S. Pat. No. 3,953,566 to Gore, U.S. Pat. No. 5,814,405 to Branca, U.S. Pat. No. 7,306,729 to Bacino, and U.S. Pat. No. 5,476,589 to Bacino.

In one embodiment, the porous membrane may have a microstructure of substantially only fibrils, as is generally taught by U.S. Pat. No. 7,306,729, to Bacino. An expanded porous membrane having substantially only fibrils as depicted may possess a high surface area, such as greater than about 20 m²/g, or greater than about 25 m²/g, and in some embodiments may provide a highly balanced strength material having a product of matrix tensile strengths in two orthogonal directions of at least 1.5×10⁵ MPa², and/or a ratio of matrix tensile strengths in two orthogonal directions of less than 2, and possibly less than 1.5. It is anticipated that expanded porous membrane may have a mean flow pore sizes of less than about 5 μm, less than about 1 μm, and less than about 0.10 μm, in accordance with embodiments. It is anticipated that expanded porous membrane may have substantially all the fibrils having a diameter of less than about 1 μm.

In another embodiment, the expanded fluoropolymer may have a microstructure of nodes interconnected by fibrils, such as described in U.S. Pat. No. 3,953,566 to Gore. The fibrils extend from the nodes in a plurality of directions, and the membrane has a generally homogeneous structure. For example, a microstructure may exhibit a ratio of matrix tensile strength in two orthogonal directions of less than 2, and possibly less than 1.5, and it will be appreciated that other ratios are suitable as well. Further, the expanded fluoropolymer membrane may have a mean flow pore sizes of less than about 5 μm, less than about 1 μm, and less than about 0.10 μm, in accordance with some embodiments. In some embodiments, the expanded fluoropolymer membrane may have fibrils in a node-fibril structure having a diameter of less than about 1 μm. In yet other embodiments, the expanded fluoropolymer membrane may have a microstructure of substantially all fibrils having a diameter of less than about 1 μm.

Non-limiting examples of suitable synthetic polymer membranes include polyurethanes, polytetrafluoroethylene (PTFE), expanded polytetrafluoroethylene (ePTFE), polyvinylidene fluoride (PVDF), fluorinated ethylene propylene (FEP), perfluoroalkoxy alkane (PFA), modified polytetrafluoroethylene polymers, tetrafluoroethylene (TFE) copolymers, polyalkylenes such as polypropylene and polyethylene, polyester sulfone (PES), polyesters, porous poly (p-xylylene) (ePPX) as taught in U.S. Patent Publication No. 2016/0032069, porous ultra-high molecular weight polyethylene (eUHMWPE) as taught in U.S. Pat. No. 9,926,416 to Sbriglia, porous ethylene tetrafluoroethylene (eETFE) as taught in U.S. Pat. No. 9,932,429 to Sbriglia, porous polylactic acid (ePLLA) as taught in U.S. Pat. No. 7,932,184 to Sbriglia, et al., porous vinylidene fluoride-co-tetrafluoroethylene or trifluoroethylene [VDF-co-(TFE or TrFE)] polymers as taught in U.S. Pat. No. 9,441,088 to Sbriglia and copolymers and combinations thereof. In at least one embodiment, the synthetic polymer membrane is a microporous synthetic polymer membrane, such as a microporous fluoropolymer membrane having a node and fibril microstructure where the nodes are interconnected by the fibrils and the pores are the voids or spaces located between the nodes and fibrils throughout the membrane. An exemplary node and fibril microstructure is described in U.S. Pat. No. 3,953,566 to Gore.

In some embodiments, the porous membrane may include one or more of the following: polytetrafluoroethylene (PTFE), ultra high molecular weight polyethylene (UHMWPE), tetrafluoroethylene (TFE) copolymers, polylactic acid (PLA), polyparaxylylene (PPX), polyvinylidene difluoride (PVDF), vinylidene difluoride (VDF) copolymers, poly(ethylene tetrafluoroethylene) (ETFE), and combinations thereof.

In one preferred embodiment, the composite material may include an expanded porous membrane made from an expanded polytetrafluoroethylene (ePTFE), for instance as generally described in U.S. Pat. No. 7,306,729, or an expanded ultra high molecular weight polyethylene (eUHMWPE).

The expanded ePTFE may include PTFE homopolymer. In alternative embodiments, blends of PTFE, expandable modified PTFE and/or expanded copolymers of PTFE may be used. Non-limiting examples of suitable fluoropolymer materials are described in, for example, U.S. Pat. No. 4,576,869 to Malhotra, U.S. Pat. Nos. 5,814,405 and 5,708,044 to Branca, U.S. Pat. No. 6,541,589 to Baillie, U.S. Pat. No. 7,531,611 to Sabol, U.S. Pat. No. 8,637,144 to Ford, and U.S. Pat. No. 9,139,669 to Xu.

Porous membranes according to embodiments may have matrix tensile strengths ranging from about 50 MPa to about 2000 MPa or greater, based on a density of about 2.18 g/cm³ for PTFE.

The porous membrane of the present embodiments may be tailored to have any suitable thickness and mass to achieve the desired composite material performance. In some cases, it may be desirable to use a very thin expanded porous membrane having a thickness less than about 10.0 μm. In other embodiments, it may be desirable to use an expanded porous membrane having a thickness greater than about 15 μm and less than about 250 μm. The expanded porous membranes can possess a specific mass less than about 5 g/m² to greater than about 200 g/m².

The multiple types of PILs which may be included in the composite material may include PILs where a cation selected from the group consisting of ammonium, imidazolium, pyridinium, phosphonium, and pyrrolidone, and a counter anion selected from the group consisting of halide, bistrifluoromethylsulfonimide, tetrafluoroborate, and acetate. The counter anion may also be a poly(anion).

In some embodiments, for example, the PILs may include poly (diallyldimethylammonium) bis(trifluoromethane)sulfonimide(PDDMATFSI), poly (diallyldimethylammonium) chloride(PDDMACI), poly (diallyldimethylammonium) tetrafluoroborate(PDDMABF4), poly ((vinylbenzyl) trimethylammonium) bis(trifluoromethane)sulfonimide(PVBTMATFSI), poly ((vinylbenzyl) trimethylammonium) chloride, (PVBTMACI), poly ((vinylbenzyl) trimethylammonium) tetrafluoroborate (PVBTMABF4), or poly ((vinylbenzyl) trimethylammonium) acetate(PVBTMAOAc).

In one embodiment, the PILs occupies substantially all of the void volume or space within the porous structure of the expanded porous membrane. Alternatively, the PILs may partially fill the void volume of the expanded porous membrane or the PILs may fill the entirety, i.e. 100%, of the void volume, which may also be referred to a fully filled. In another embodiment the PILs is present in substantially all or part of the pores of the expanded porous membrane. In yet another embodiment, the PILs may form a coating on the nodes and fibrils of the expanded porous membrane. For example, the PILs may fill at least a portion of the void volume of the expanded porous membrane, wherein a portion may be defined as about 10%, about 20%, about 30%, about 40%, or about 50%. Or the PILs may fill a majority of the void volume of the expanded porous membrane, where a majority may be defined as about 50%, about 60%, about 70%, about 80%, or about 90%.

In a further embodiment, the composite material may have a porosity of greater than about 20%, greater than about 30%, greater than about 40%, greater than about 50%, greater than about 60%, greater than about 70%, greater than about 80%, or greater than about 90%. The composite material may have a porosity of less than about 95%, less than about 90%, less than about 80%, less than about 70%, less than about 60%, less than about 50%, less than about 40%, less than about 30%, or less than about 20%. The composite material may have a porosity in a range of from greater than about 20% to about 90%, or may have any porosity encompassed by these endpoints. It should also be readily appreciated that where the porosity is too small, the gas permeability may be reduced.

The porous membrane may have a void volume providing pores. The pores may have an average diameter in a range of from about 0.001 μm to about 10 μm, or may have an average diameter encompassed by these endpoints.

Additional materials may be incorporated into the pores or within the composite material or in between the layers of a laminate including the composite material to enhance or tailor the desired properties of composite material or laminate. In one embodiment, the composite material may contain at least one active agent. The active agent may be covalently or non-covalently bound to the PILs. Examples of active agents may include inorganic particles, inorganic nanoparticles, metals, metal oxides, metal salts, carbon nanotubes (CNTs), fullerenes, graphene, catalytic particles, polyoxometalates (POMs), metal organic frameworks (MOFs), additional polymers, silica, quantum dots, ionic liquids, and biologically active molecules.

Biologically active molecule may include, for example, polypeptide, protein, enzyme catalyst, enzymes, enzyme extracts, whole cells, antibody, lipid, nucleic acid molecule, or carbohydrate.

The weight percent of the PILs polymer relative to the total weight of the composite material may range from 1 wt % to 90 wt % in any of the embodiments, or the weight percent of the PILs polymer relative to the total weight of the composite material may be any percentage falling between these endpoints.

The composite material or laminate, according to an embodiment of the present invention, may be utilized as a CO₂ separation membrane, the composite materials exhibiting high CO₂ permeability and CO₂/N₂ selectivity. For examples, the composite material may have a CO₂ permeability of more than 1.0 barrer, or more than 2.0 barrer, or more than 3.0 barrer, or more than 4.0 barrer, or more than 5.0 barrer, or more than 6.0 barrer, or more than 7.0 barrer, or more than 8.0 barrer, or more than 9.0 barrer, or more than 9.5 barrer, or more than 10.0 barrer, where 1.0 barrer is 3.35×10⁻¹⁶ mol·m/(s·m²·Pa). Similarly, the composite material may have a N₂ permeability of less than 1.5 barrer, less than 1.3 barrer, or less than 1.1 barrer. In some embodiments, the composite material may have a CO₂ permeability of from about 1.0 barrer to about 4.0 barrer, or from about 1.0 barrer to about 3.0 barrer, or from about 1.0 barrer to about 2.0 barrer, or from about 1.0 barrer to about 1.5 barrer, or from about 1.0 barrer to about 1.4 barrer, or from about 1.0 barrer to about 1.3 barrer, or from about 1.0 barrer to about 1.2 barrer, or from about 1.0 barrer to about 1.1 barrer, or may have a CO₂ permeability of any value encompassed by these endpoints. The composite material may have a selectivity calculated as CO₂ permeability/N₂ permeability of greater than 8.0, greater than 9.0, or greater than 10.0.

Similarly, the composite material or laminate, according to an embodiment of the present invention, may have a high CO₂ absorption capacity. The composite membrane may have a higher absorption per mass of PILs in the composite than that in the PILs powder. For example, the composite material may have a CO₂ absorption capacity greater than 0.3 mmol CO₂/g PILs, greater than 0.4 mmol CO₂/g PILs, greater than 0.5 mmol CO₂/g PILs, greater than 0.6 mmol CO₂/g PILs, greater than 0.7 mmol CO₂/g PILs, greater than 0.8 mmol CO₂/g PILs, greater than 0.9 mmol CO₂/g PILs, greater than 1.0 mmol CO₂/g PILs, greater than 1.5 mmol CO₂/g PILs, or greater than 2.0 mmol CO₂/g PILs. The composite material may have a CO₂ absorption capacity of from about 0.3 mmol CO₂/g PILs to about 2.0 mmol CO₂/g PILs.

In some embodiments, the composite material is thin and may have a thickness less than about 1000 μm (1.0 mm), less than about 500 μm, less than about 100 μm, less than about 50 μm, less than about 10 μm, less than about 1 μm, less than about 0.5 μm, or less than about 0.1 μm, or less than about 0.05 μm. For example, the composite material may have a thickness from about 0.04 μm to about 1.0 mm, or may have a thickness of any value encompassed with this range.

The composite material may include a substrate or support layer, and may be laminated, adhered, or otherwise bonded (e.g., thermally, mechanically, or chemically) to a substrate or support layer. Non-limiting examples of suitable substrates or support layers include, but are not limited to, fluorinated ethylene propylene (FEP), perfluoroalkoxy alkane (PFA), polytetrafluoroethylene (PTFE), a terpolymer of tetrafluoroethylene, hexafluoropropylene, and vinylidene fluoride (THV), polyurethanes, polyamides, ethylene vinyl alcohol (EVOH), and polyvinyl chloride (PVC). The substrate may also be a metallic sheet, an inorganic sheet, or pressure sensitive adhesive. Such laminated structures may facilitate or enhance further bonding to additional layers, such as textiles. The substrate or support layer may include a textile layer may include a knit material, a woven material or a non-woven material.

The laminates including the composite material may have one or more layers, for examples two layers or three layers, or more. In one embodiment, the composite material may be positioned between a first layer and a second layer.

Articles or laminates that include the composite material may exhibit excellent absorption and mechanical properties. An article that includes the composite material may be in the form of a sheet, a tube, or a self-supporting three-dimensional shape. Or the article may be included in a laminate or composite. The composite material, article or laminate may be used in application such as direct air capture for CO₂ sequestration, gas absorption from a fluid stream, for examples the CO₂ capture and separation in, e.g., power plant flue gases, as a CO₂ sensor, or in applications requiring the separation of CO₂/N₂ or CO₂/CH₄.

As discussed above, the PILs is combined with the expanded porous membrane such that the PILs partially or substantially fully fills of the void volume or pores within the expanded porous membrane. This filling of the pores of the expanded porous membrane with PILs can be performed by a variety of methods, such as imbibing with a draw down bar, wire bar, gravure rolling or spin coating. In one embodiment, a method of filling the pores of an expanded porous membrane includes the steps of dissolving the poly(ionic liquid)s in a solvent suitable to create a solution with a viscosity and surface tension that is appropriate to partially or fully flow into the pores of the expanded porous membrane and allow the solvent to evaporate, leaving the PILs behind.

In various embodiments, the composite material can include an imbibed zone and a non-imbibed zone, where an imbibed zone can be formed, for example, by imbibing a porous membrane with a PILs in a portion of the porous membrane. Such an imbibed zone can be formed by, for example, “butter coating” or slot die coating.

In one embodiment, a method of forming a composite material, may include dissolving a solid PILs polymer in a solvent to form a PILs polymer solution; applying the PILs polymer solution to a porous polymer membrane having a void volume providing pores and a microstructure of nodes interconnected by fibrils or only fibrils; and removing the solvent after applying the PILs polymer solution to the porous polymer membrane. The PILs polymer may be partially or fully imbibed into the void volume of the microstructure of the porous polymer membrane.

In another embodiment, a method of forming a composite material, may include spin coating. For example, a composite material may be formed by providing a PILs polymer solution; and an expanded porous membrane having a first side and a second side; where the expanded porous membrane has a void volume providing pores and a microstructure of fibrils, and optionally nodes interconnecting the fibrils, and spinning the PILs solution to the membrane where the PILs polymer solution is deposited on at least one side of the expanded porous membrane whereby the composite material is formed.

It should be readily appreciated that additional processing steps are within the spirit of the present embodiments. Additional processing may include optionally subjecting the composite material to one or more steps of heating, stretching, compacting, compressing, or any combination thereof. For example, the composite material may be expanded after applying the PILs polymer solution to a porous polymer, or after removing the solvent after applying the PILs polymer solution, or after each of these process steps. In other embodiments, the composite material may be compressed after applying the PILs polymer solution to a porous polymer, or after removing the solvent after applying the PILs polymer solution, or after expanding the composite material, or after each of these process steps. The inventors have found that a combination of these unique processing capabilities allows manipulating the ePTFE pore structure, porosity and the density of the composite membrane which then provides adequate support of the fragile PILs membrane while simultaneously allowing to optimize the permeability and selectivity.

In summary, the composite material, and articles or laminates that include the composite material, prepared by the processes provided herein exhibit a combination of desirable absorption properties including high CO₂ permeability and CO₂/N₂ selectivity, as well as highly desirable mechanical properties, including flexibility, strength, and durability. The processes presented herein provide for support of the fragile PILs membrane while simultaneously allowing to optimize the permeability and selectivity though unique processing capabilities to manipulate the ePTFE pore structure, porosity and the density of the composite membrane.

### Test Methods

It should be understood that although certain methods and equipment are described below, other methods or equipment determined suitable by one of ordinary skill in the art may be alternatively utilized.

Unless defined otherwise herein, all technical and scientific terms used herein have the same meaning as commonly understood by one of ordinary skill in the art. Invention concepts are further defined in the following Examples. It should be understood that these Examples, while indicating preferred invention embodiments, are given by way of illustration only. From the above discussion and these Examples, one skilled in the art can ascertain the essential characteristics according to some embodiments, and without departing from the spirit and scope thereof, can make various changes and modifications of invention concepts to adapt them to various uses and conditions.

### Thermogravimetric Analysis (TGA)

Thermogravimetric sorption data was collected using a Discovery TGA 5500 thermogravimetric analyzer from TA Instruments (New Castle, DE). Carbon dioxide and helium were plumbed to the thermogravimetric analyzer.

### CO₂ Sorption Method 1

CO₂ Sorption Method 1 utilized the following process steps:

| Program step | Description |
|---|---|
| 1 Select Gas 1 | Purge with helium at 25 mL/min |
| 2 Ramp 20° C./min to 70° C. | Heat to 70° C. for degassing |
| 3 Isothermal for 300 min | Degas for 5 hours |
| 4 Ramp 20° C./min to 30° C. | Cool to 30° C. for sorption analysis |
| 5 Isothermal for 30 min | Allow time for temp to stabilize |
| 6 Select Gas 2 | Purge with CO₂ at 25 mL/min |
| 7 Isothermal for 60 min | Measure mass uptake during adsorption |
| 8 Select Gas 1 | Purge with helium at 25 mL/min |
| 9 Isothermal for 60 min | Measure mass decrease during desorption |
| 10 Repeat 6-9 for 3 times | Repeat the cycle 3 times to assess |
| | reproducibility |

### CO₂ Sorption Method 2

CO₂ Sorption Method 2 for measurement of adsorption/desorption kinetics utilized the following process steps:

| Program step | Description |
|---|---|
| 1 Data Storage On | |
| 2 Select Gas 1 | Purge with helium at 25 mL/min |
| 3 Ramp 10° C./min to 100° C. | Heat to 100° C. for degassing |
| 4 Isothermal for 120 min | Degas for 2 hours |
| 5 Ramp 10° C./min to 30° C. | Cool to 30° C. for sorption analysis |
| 6 Isothermal for 30 min | Allow time for temp to stabilize |
| 7 Select Gas 2 | Purge with CO₂ at 25 mL/min |
| 8 Isothermal for 480 min | Measure mass uptake during adsorption |
| 9 Select Gas 1 | Purge with helium at 25 mL/min |
| 10 Ramp 10° C./min to 100° C. | Heat for desorption analysis |
| 11 Isothermal for 120 min | Measure mass decrease during |
| | desorption |
| 12 Data storage off | |
| 13 Ramp 10° C./min to 30° C. | |

### CO₂ Sorption Method 3 (Temperature Swing Absorption/Desorption Cycling, TSA)

CO₂ Sorption Method 3 utilizes the following steps:

| Program step | | Description |
|---|---|---|
| 1. | Data storage: On | |
| 2. | Gas 1: N₂ | Purge with nitrogen for 2 hrs at |
| | | 90 mL/min |
| 3. | Ramp: 10° C./min to 100° C. | Heat to 100° C. for degassing |
| 4. | Isothermal: 120 min | Degas for 2 hours |
| 5. | Ramp: 10° C./min to 30° C. | Cool to 30° C. for sorption |
| | | analysis |
| 6. | Equilibrate at 30° C. | Allow time for temp to stabilize |
| 7. | Gas 2: CO₂ | Purge with CO₂ at 90 mL/min |
| 8. | Isothermal: 60 min | Measure mass uptake during |
| | | adsorption |
| 11. | Gas 1: N₂ | Purge with nitrogen at 90 |
| | | mL/min |
| 12. | Ramp: 10° C./min to 100° C. | Heat for desorption analysis |
| 13. | Isothermal: 30 min | Measure mass decrease during |
| | | desorption |
| 14. | Repeat sequence 6-13 for 10 times | |
| 15. | Data storage: Off | |
| 16. | Ramp: 10° C./min to 30° C. | |

### ATEQ Airflow

ATEQ Airflow is a test method for measuring laminar volumetric flow rates of air through membrane samples. For each membrane, a sample was clamped between two plates in a manner that seals an area of 2.99 cm² across the flow pathway. An ATEQ® (ATEQ Corp., Livonia, MI) Premier D Compact Flow Tester was used to measure airflow rate (L/hr) through each membrane sample by challenging it with a differential air pressure of 1.2 kPa (12 mbar) through the membrane.

### Bubble Point

Bubble point pressures were measured according to the general teachings of ASTM F31 6-03 using a Capillary Flow Porometer (Model 3Gzh from Quantachrome Instruments, Boynton Beach, Florida). The sample membrane was placed into the sample chamber and wet with Silwick Silicone Fluid (available from Porous Materials Inc.) having a surface tension of 20.1 dynes/cm. The bottom clamp of the sample chamber had a 2.54 cm diameter, 0.159 cm thick porous metal disc insert (Quantachrome part number 75461 stainless steel filter) and was used to support the sample. Using the 3GWin software version 2.1, the following parameters were set as specified in the table immediately below. The values presented for bubble point pressure are the average of two measurements. Bubble point pressure was converted to pore size using the following equation:

D_{BP}=4γₗᵥ cos θ/P_{BP}
where D_{BP} is the pore size, γₗᵥ is the liquid surface tension, θ is the contact angle of the fluid on the material surface, and P_{BP} is the bubble point pressure. It is understood by one skilled in the art that the fluid used in a bubble point measurement must wet the surface of the sample.

### Bubble Point Instrument Settings

| Parameter | | |
|---|---|---|
| Run Settings | | |
| Starting pressure | 2.12 | psig |
| Ending pressure | 85.74 | psig |
| Sample Area | 3.14 | cm² |

| | |
|---|---|
| Run Type | Wet Only |
| Number Data Points | 256 |
| Pressure Control | |
| Use Normal Equilibrium | TRUE |
| Use Tol | FALSE |
| Use Time | FALSE |
| Use Rate | FALSE |
| Use Low Flow Sensor | FALSE |
| Time Out | NA |
| Equil Time | NA |
| Run Rate | NA |
| Pressure Tolerance | NA |
| Flow Tolerance | NA |
| Smoothing | |
| UseMovAve | FALSE |
| MovAveWet Interval | NA |
| MovAveDry Interval | NA |
| Lowess Dry | 0.050 |
| Lowess Wet | 0.050 |
| Lowess Flow | 0.050 |
| Lowess Num | 0.100 |
| MinSize Threshold | 0.98 |
| Bubble Point Parameters | |
| UseBpAuto | TRUE |
| UseBpThreshold (L/min) | FALSE |
| UseBpThreshold (Abs/cm2) | FALSE |
| UseBpThresholdNumber | FALSE |
| BpAuto Tolerance (manual) | 1% |
| BpThresholdValue (manual) | NA |
| BpThreshold (abs/cm2) | 0 |
| value | |

### Thickness Measurements (Contact Using Snap Gauge)

Membrane thickness was measured by placing the membrane between the two plates of a Kafer FZ1000/30 thickness snap gauge (Kafer Messuhrenfabrik GmbH, Villingen-Schwenningen, Germany). The average of the three measurements was used.

Laminate thickness was determined by placing the membrane between the two plates of a Mitutoyo Tektronix snap gauge (Part Number 547-400S).

### Mass Per Area (Mass/Area)

The mass per area of samples was measured according to the ASTM D 3776 (Standard Test Methods for Mass Per Unit Area (Weight) of Fabric) test method (Option C) using a Mettler-Toledo Scale, Model 1060. The scale was recalibrated prior to weighing specimens, and the results were reported in grams per square meter (g/m2).

### Matrix Tensile Strength Determination

A membrane was cut in each of the longitudinal and transverse directions using an ASTM D412-Dogbone die Type F (D412F). The “machine direction” is in the direction of the extrusion and the “transverse direction” is perpendicular to this. Once the dogbone samples were prepared, they were measured to determine their mass using, a Mettler Toledo scale, model AG204.

Tensile break load was measured using an INSTRON® 550CR (Illinois Tool Works Inc., Norwood, MA) tensile test machine equipped with a rubber coated face plate and a serrated face plate such that each end of the sample was held between one rubber coated plate and one serrated plate. The pressure that was applied to the grip plates was approximately 552 kPa. The gauge length between the grips was set at 58.9 mm and the crosshead speed (pulling speed) was set to a speed of 508 mm/min. A 500 N load cell was used to carry out these measurements and data was collected at a rate of 50 points/sec. The laboratory temperature was between 2° and 22.2° C. to ensure comparable results. If the sample broke at the grip interface, the data was discarded. At least 3 samples in the machine direction and three samples in the transverse direction were successfully pulled (no slipping out of or breaking at the grips) in order to characterize the sample.

The following equation was used to calculate the matrix tensile strength (MTS):

$$MTS = F / A$$

Where F is the maximum load in the test, A is the x-section area of PTFE. The x-section area of PTFE is not the same as the x-section area of the specimen due to potential pores/defects in the sample. The x-section area of PTFE can be calculated as follows:

$$A = \frac{m}{l * ρ}$$

Where m is the mass of the testing specimen, L is the length of the specimen, and □ is the mean intrinsic density of PTFE, which is 2.18 g/cc.

### EXAMPLES

### Expanded Polytetrafluoroethylene (ePTFE) Membranes

This invention can utilize a variety of porous PTFE membranes known in the art, where different PTFE fine powders or fine powder blends may be used based on teachings by U.S. Pat. No. 4,576,869 to Malhotra, U.S. Pat. Nos. 5,814,405 and 5,708,044 to Branca, or modified PTFE resin powders such as that described in U.S. Pat. No. 6,541,589 to Baillie, U.S. Pat. No. 7,531,611 to Sabol, U.S. Pat. No. 8,637,144 to Ford, and U.S. Pat. No. 9,139,669 to Xu. The PTFE fine powders may be formed into membranes using process methodology known to those skilled in the art, such as that described in U.S. Pat. No. 3,953,566 to Gore, U.S. Pat. No. 5,814,405 to Branca, U.S. Pat. No. 7,306,729 to Bacino, and U.S. Pat. No. 5,476,589 to Bacino.

ePTFE Membrane Type A. Membrane Type A was prepared using a fine powder of high molecular weight PTFE polymer produced by the process described in U.S. Pat. No. 4,576,869 to Malhotra. The resulting properties are provided in Table 1.

ePTFE Membrane Type B. Membrane Type B was produced by applying a hydrophilic polymer coating (ethylene vinyl alcohol copolymer; EVOH) to an expanded ePTFE membrane (ePTFE Membrane Type A, produced as describe above). Briefly, a 2 wt % coating solution was prepared by dissolving SOARANOL™ EVOH (Mitsubishi Chemical Corp., Tokyo, JP; Product number DT2904; approximately 29 mol % ethylene content) in an ethanol and water mixture. The coating solution was applied to the ePTFE membrane at room temperature (˜22° C.) at 1 meter/min using a wire bar and then dried at 70° C. in a continuous process. The coated eTPFE membrane was hydrophilic and instantly wettable. The resulting properties are provided in Table 1.

ePTFE Membrane Type C. Membrane Type C was prepared using a fine powder of high molecular weight PTFE polymer produced by the process described in U.S. Pat. No. 4,576,869 to Malhotra. The resulting properties are provided in Table 1.

ePTFE Membrane Type D. Membrane Type D was prepared using a fine powder PTFE blend (˜50 wt % PTFE homopolymer and ˜50 wt % modified PTFE resin) as described in Example 1 of U.S. Pat. No. 5,814,405 to Branca. The resulting properties are provided in Table 1.

TABLE 1
ePTFE Membranes Properties

| | | | | | Matrix | Matrix |
|---|---|---|---|---|---|---|
| | Mass | | | ATEQ | Tensile | Tensile |
| | per | | Bubble | Airflow | Strength - | Strength - |
| ePTFE | area | Thickness | Point | (L/hr) @ 12 | MD | TD |
| Membrane | (g/m²) | (μm) | (kPa) | mbar | (MPa) | (MPa) |
| Type A | 21.0 | 36.1 | 186.2 | 8.6 | 53.3 | 143.1 |
| Type B | 20.7 | 23.0 | Not determined | 4.0 | 55.2 | 112.4 |
| Type C | 22.2 | 31.5 | 204.1 | 8.2 | 106.1 | 205.0 |
| Type D | 129.0 | 207.0 | 30.4 | 45.4 | 114.5 | 36.1 |

### Poly(Ionic Liquid)s

The following acronyms are used herein. PDDMA=poly (diallyldimethylammonium); PVBTMA=poly ((vinylbenzyl) trimethylammonium); TFSI=bis(trifluoromethane) sulfonimide; Cl=chloride; BF₄=tetrafluoroborate; and OAc=acetate. The poly(ionic liquid)s were acquired from the following venders. PDDMACI was from Sigma-Aldrich, (Product No. 409022, CAS No. 26062-79-3, Mw=200,000-350,000 g/mol) and PVBTMACI was from Scientific Polymer Products Inc. (Cat. No. 879, CAS No. 9017-80-5, Mw=400,000 g/mol). Others were prepared as described below. Conversion between the different poly(ionic liquid)s is through a metathesis type reaction starting with the poly(ionic liquid)s in the chloride form (see Example 1).

TABLE 2
Poly(ionic liquid)s used in the examples

| Polyionic liquid | Cation | Anion |
|---|---|---|
| poly (diallyldimethylammonium) | PDDMA | TFSI |
| bis(trifluoromethane)sulfonimide | | |
| (PDDMATFSI) | | |
| poly (diallyldimethylammonium) chloride | PDDMA | Cl |
| (PDDMACl) | | |
| poly (diallyldimethylammonium) tetrafluoroborate | PDDMA | BF₄ |
| (PDDMABF₄) | | |
| poly ((vinylbenzyl) trimethylammonium) | PVBTMA | TFSI |
| bis(trifluoromethane)sulfonimide | | |
| (PVBTMATFSI) | | |
| poly ((vinylbenzyl) trimethylammonium) chloride | PVBTMA | Cl |
| (PVBTMACl) | | |
| poly ((vinylbenzyl) trimethylammonium) | PVBTMA | BF₄ |
| tetrafluoroborate (PVBTMABF₄) | | |
| poly ((vinylbenzyl) trimethylammonium) acetate | PVBTMA | OAc |
| (PVBTMAOAc) | | |

### Example 1

### Conversion of PDDMACI to PDDMATFSI

Approximately 200 grams of lithium bis(trifluoromethane)sulfonimide (LiTFSI) was mixed with 1.5 L of water (RO, reverse osmosis, H₂O) in a 3-liter beaker equipped with a mechanical stirring rod. The mixture was stirred at room temperature (˜22° C.). A solution of PDDMACI (500 grams of a 20 wt % aqueous solution) was mixed with 1 L more water. This solution was placed in an addition funnel (1500 mL). The PDDMACI aqueous solution was then added dropwise into the LiTFSI aqueous solution while stirring. The resulting mixture contained LiCl dissolved in water and a precipitate of PDDMATFSI. The PDDMATFSI solid was filtered, washed in 3 L of water for 30 minutes. This was repeated 3 times. The precipitate was filtered and then dried at 60° C. for 4 hours and then 100° C. overnight. The resulting yield was 48.27%.

### Example 2

### Preparation of Composite Membranes

The poly(ionic liquid)s (PILs) was dissolved in a suitable solvent to a target concentration ranging from 2 wt % to 20 wt % depending upon the poly(ionic liquid)s/solvent combination. The resulting solution was applied to an expanded polytetrafluoroethylene (ePTFE) membrane that was restrained within a hoop. The solution was spread over the surface of the restrained membrane until the membrane was completely coated. The solution coated ePTFE membrane was then dried in air at room temperature (˜22° C.) or in a drying oven at 70-120° C. for approximately 5 minutes, which normally results in a node-fibril (NF) coated membrane. Fully imbibed (FI) composite membranes were prepared by additional rounds of coating/drying and/or use of more concentrated imbibing solutions.

TABLE 3
ePTFE/PILs composite membranes compositions

| | | Polyionic | | Imbibing | Wt % PIL in | |
|---|---|---|---|---|---|---|
| | ePTFE | Liquid | | Solution | Dried | Partial or |
| Composite | Membrane | (PIL) | | Concentration | Composite | Fully |
| Sample | Type | Used | Solvent | (wt %) | Membrane | Imbibed |
| 1 | A | PDDMATFSI | 2-butanone | 14.8 | 36.0 | FI |
| 2 | A | PVBTMAOAc | EtOH | 8.8 | 19.0 | NF |
| 3 | B | PVBTMACl | H₂O | 16.0 | 32.0 | NF |
| 4 | C | PDDMATFSI | 2-butanone | 15.0 | 43.0 | FI |
| 5 | D | PDDMATFSI | 2-butanone | 9.8 | 11.4 | NF |
| 6 | B | PDDMACl | H₂O | 2.2 | 28.4 | NF |
| 7 | B | PDDMACl | H₂O | 20.0 | 64.0 | FI |
| 8 | A | PVBTMAOAc | EtOH | 15.8 | 35 | FI |

### Example 3

### Preparation of Laminates

Various multi-layer laminates were prepared by bonding at least one of the composite membranes from Example 2 to another composite membrane and/or at least one reinforcement layer. A 2-roller compression machine was used to compress two or more layers together using a force of 400 N/mm at a speed of 1 in/mm. The properties of the formed laminates are provided in Table 4. Other methods of compression can be implemented such as stacking the layers in a hydraulic hand press and pressing the layers together with heat forming a final laminate. Another composite utilizing densified PTFE film was created in the same manner as those utilizing ePTFE membrane as the external layers.

TABLE 4
Examples of ePTFE/PILs composite membrane laminates

| | | | | Final | |
|---|---|---|---|---|---|
| | | | | laminate | |
| Laminate | | | | thickness | PILs in |
| Sample | Layer 1 | Layer 2 | Layer 3 | (μm) | composite |
| 1 | ePTFE | Composite | ePTFE | 36 | PDDMATFSI |
| | Type A | sample 4 | Type A | | |
| 2 | ePTFE | Composite | ePTFE | 40 | PVBTMACl |
| | Type A | sample 3 | Type A | | |
| 3 | ePTFE | Composite | ePTFE | 18 | PVBTMAOAc |
| | Type A | sample 2 | Type A | | |
| 4 | ePTFE | Composite | ePTFE | 15 | PDDMACl |
| | Type A | sample 7 | Type A | | |
| 5 | Dense | Composite | Dense | 25 | PDDMACl |
| | PTFE | sample 7 | PTFE | | |
| 6 | Dense | Composite | Dense | 16 | PVBTMAOAc |
| | PTFE | sample 2 | PTFE | | |

### Example 4

### CO₂ Absorption Analysis

Test samples of a PILs powder, or a composite membrane were placed in a thermogravimetric analyzer (TGA) system for CO₂ absorption analysis as described in CO₂ Sorption Method 1. The test is initiated by degassing the sample at 70° C. or 120° C. for 5 hours. The degassed sample was then cooled to 30° C. and then carbon dioxide (CO₂) gas (100% at 30° C.) is introduced into the system. The amount of CO₂ absorbed is determined by the weight increase of the sample over 60 minutes or until saturation is reached (maximum weight). The environment within the system is then changed to Helium and the absorbed CO₂ in the test sample is desorbed. The weight decreases and then a minimum weight is established after about 60 minutes. The difference between maximum and minimum is taken as the working capacity. This can then be converted to millimoles of CO₂ per gram of poly(ionic liquid)s (mmol/g). Absorption results are provided in Table 5 (PILs powders degassed at 70° C.), Table 6 (PILs powders degassed at 120° C.), Table 7 (ePTFE composites degassed at 70° C.), and Table 8 (ePTFE composites degassed at 120° C.).

TABLE 5
Absorption analysis results for PILs powder degassed at 70° C.

| Material Test Degassed at 70° C. | | | CO₂ absorption | |
|---|---|---|---|---|
| Sample | | | WC | |
| No. | Cation | Anion | (%) | mmol CO₂/g PILs |
| 1 | PDDMA | Cl | 1.4 | 0.32 |
| 2 | PDDMA | OAc | 0.4 | 0.09 |
| 3 | PDDMA | BF₄ | 0.2 | 0.05 |
| 4 | PVBTMA | OAc | 1.1 | 0.25 |
| 5 | PVBTMA | BF₄ | 0.5 | 0.11 |
| 6 | PVBTMA | Cl | 0.3 | 0.07 |

TABLE 6
Absorption analysis results for PILs powder degassed at 120° C.

| Material Test Degassed at 120° C. | | | CO₂ absorption | |
|---|---|---|---|---|
| Sample | | | WC | |
| No. | Cation | Anion | (%) | mmol CO₂/g PILs |
| 7 | PDDMA | Cl | 0.3 | 0.07 |
| 8 | PDDMA | OAc | 0.3 | 0.07 |
| 9 | PVBTMA | Cl | 0.1 | 0.02 |
| 10 | PVBTMA | OAc | 1.2 | 0.29 |

TABLE 7
Absorption analysis results for composite
membranes degassed at 70° C.

| Material Test Degassed | | | CO₂ absorption | | | |
|---|---|---|---|---|---|---|
| at Temp 70° C. | | | | mmol | type | |
| Sample | | | WC | CO₂/g | NF or | % |
| No. | cation | anion | (%) | PILs | FI | PILs |
| 1 | PVBTMA | Cl | 0.5 | 0.36 | NF | 22 |
| 2 | PVBTMA | Cl | 0.2 | 0.60 | NF | 8 |
| 3 | PVBTMA | OAc | 0.3 | 0.35 | NF/BC | 19 |
| 4 | PVBTMA | OAc | 1.0 | 0.66 | FI | 35 |

TABLE 8
Absorption analysis results for composite
membranes degassed at 120° C.

| Material Test Degassed | | | CO₂ absorption | | | |
|---|---|---|---|---|---|---|
| at Temp 120° C. | | | | mmol | type | |
| Sample | | | WC | CO₂/g | NF or | % |
| No. | cation | anion | (%) | PILs | FI | PILs |
| 5 | PVBTMA | Cl | 0.2 | 0.60 | NF | 8 |
| 6 | PVBTMA | OAc | 0.4 | 0.26 | FI | 35 |
| 7 | PVBTMA | OAc | 0.3 | 0.35 | NF/BC | 19 |

In Tables 7 and 8, NF refers to node and fibril coating, BC refers to butter coating and FI refers to fully imbibed.

### Example 5

### Selectivity Permeability Analysis

### CO₂ vs. N₂

Permeability testing was acquired using a Lab Think Perme VacV2 permeability tester following the ASTM method D1434. Samples were tested by inserting the film into the tester, a single gas (CO₂) was selected. After the end of that test, a different gas (N₂) was selected and the test was run on the same sample. The gas transmission rate (GTR) was then normalized by the thickness and the permeability coefficient was calculated for each film.

Selectivity is calculated as the ratio of CO₂ permeability over N₂ permeability for a given composite membrane.

3-layer laminates were constructed and compressed as described in example 3. The control is a 3-layer laminate without being imbibed with PILs and only contains 3 layers of ePTFE membranes, which was also compressed as described in example 3.

TABLE 9
Permeability and Selectivity of Laminates.

| Laminate | Permeability | | | | | |
|---|---|---|---|---|---|---|
| Sample | (Barrer) | | Selectivity | | Com- | Lami- |
| No. | CO₂ | N₂ | CO₂/N₂ | PILs Type | posite | nate |
| 1 | 9.0 | 1.7 | 5.4 | none | control | 3 Layer |
| 2 | 10.0 | 0.8 | 12.5 | PDDMATFSI | FI | 3 Layer |
| 3 | 10.2 | 0.9 | 11.1 | PDDMATFSI | NF | 3 Layer |
| 4 | 1.8 | 0.2 | 11.6 | PVBTMACl | NF | 3 Layer |
| 5 | 5.0 | 0.4 | 13.4 | PVBTMAOAc | NF | 3 Layer |

### Example 6

### Kinetic Adsorption and Desorption of CO₂

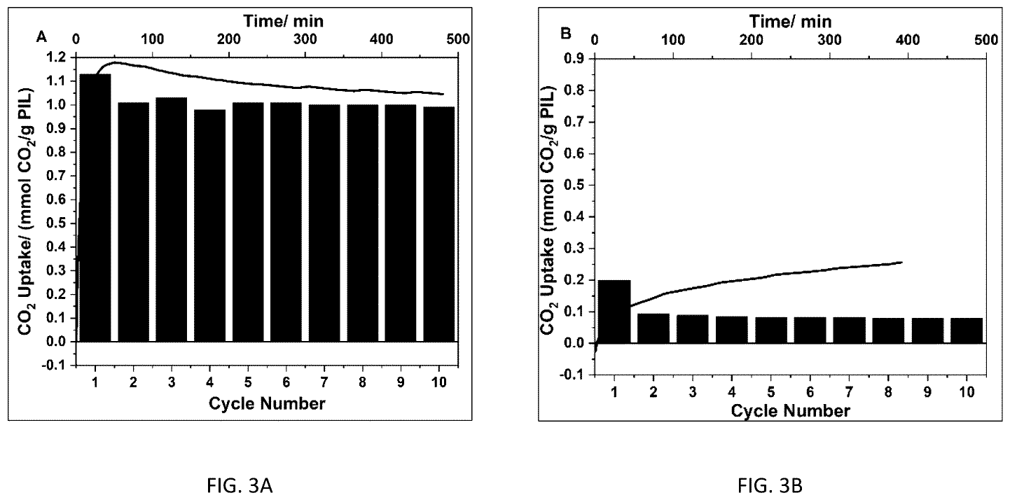

Kinetic Adsorption/Desorption of CO₂ was determined using CO₂ Sorption Method 2. Kinetic data was measured for both a composite ePTFE PVBTMAOAc membrane (Sample 4 from Table 7) as well as PVBTMAOAc powder (Sample 4 from Table 5). The data was collected and plotted in FIGS. 3A and 3B. The line plot represents the kinetic curve recorded for 8 hours of continuous CO₂ adsorption (100% CO₂; 30° C.).

The bars in FIGS. 3A and 3B represent the CO₂ uptake recorded for each cycle under temperature-swing adsorption desorption cycling following CO₂ Sorption Method 3 (10 cycles, conditions: All samples were isothermally heated at 100° C. for 2 hours under N₂ flow for degassing in the TGA (Method 3 step 4). Adsorption: 30° C., 100% CO₂ for 1 hour; Desorption: 100° C., 100% N₂ for 30 min). The flow rate for the two series of experiments was 90 mL/min. All experiments were performed under dry conditions.

1. A composite material comprising:
an expanded porous membrane having a thickness, where the expanded porous membrane has a microstructure of fibrils, and optionally nodes interconnecting the fibrils, and a void volume providing pores; and a poly(ionic liquid)s polymer (PILs), wherein the PILs is selected from the group consisting of poly (diallyldimethylammonium) bis(trifluoromethane)sulfonimide(PDDMATFSI), poly (diallyldimethylammonium) chloride(PDDMACI), poly (diallyldimethylammonium) tetrafluoroborate(PDDMABF4), poly ((vinylbenzyl) trimethylammonium) bis(trifluoromethane)sulfonimide(PVBTMATFSI), poly ((vinylbenzyl) trimethylammonium) chloride, (PVBTMACI), poly ((vinylbenzyl) trimethylammonium) tetrafluoroborate (PVBTMABF4), and poly ((vinylbenzyl) trimethylammonium) acetate(PVBTMAOAc).

2. The composite material of claim 1, wherein the PILs forms a coating on the nodes and fibrils of the expanded porous membrane.

3. The composite material of claim 1, wherein the PILs fills the entirety of the void volume of the expanded porous membrane or wherein the PILs fills at least a portion of the void volume of the expanded porous membrane, or wherein the PILs fills a majority of the void volume of the expanded porous membrane.

4.-5. (canceled)

6. The composite material of claim 1 wherein the expanded porous membrane comprises one or more of the following: polytetrafluoroethylene (PTFE), ultra high molecular weight polyethylene (UHMWPE), tetrafluoroethylene (TFE) copolymers, polylactic acid (PLA), polyparaxylylene (PPX), polyvinylidene difluoride (PVDF), vinylidene difluoride (VDF) copolymers, or poly(ethylene tetrafluoroethylene) (ETFE).

7. The composite material of claim 1, wherein the expanded porous membrane comprises expanded polytetrafluoroethylene (ePTFE) or expanded ultra high molecular weight polyethylene (eUHMWPE).

8.-9. (canceled)

10. The composite material of claim 1, wherein the composite material has a porosity from greater than about 20% to about 99%, or wherein the composite material has a porosity of less than 20%.

12. The composite material of claim 1, further comprising at least one active agent.

13. The composite material of claim 12, wherein the active agent is covalently or non-covalently bound to the PILs, and wherein the active agent is selected from the group consisting of inorganic particles, inorganic nanoparticles, metals, metal oxides, metal salts, carbon nanotubes (CNTs), fullerenes, graphene, catalytic particles, polyoxometalates (POMs), metal organic frameworks (MOFs), additional polymers, silica, quantum dots, ionic liquids, biologically active molecules, and any combination thereof.

14. (canceled)

15. The composite material of claim 14, wherein the biologically active molecule is a polypeptide, protein, enzyme catalyst, enzyme, enzyme extract, whole cell, antibody, lipid, nucleic acid molecule, carbohydrate, or any combination thereof.

16. The composite material of claim 1, wherein where the weight percent of the poly(ionic liquid)s polymer relative to the total weight of the composite material ranges from about 1 wt % to about 90 wt %.

17. The composite material of claim 1, further comprising a support layer.

18. The composite material of claim 1, wherein the composite material has a CO₂ absorption capacity from about 0.3 mmol CO₂/g PILs to about 1.2 mmol CO₂/g PILs, or wherein the composite material has a CO₂ permeability of more than 1.0 barrer, or wherein the composite material has a N₂ permeability of less than 1.5 barrer, or wherein the composite material has a selectivity calculated as CO₂ permeability/N₂ permeability of greater than 8.0.

19.-21. (canceled)

22. A laminate comprising the composite material of claim 1.

23. An article comprising the composite material of claim 1.

24. A method of separating a gas from a mixture comprising providing the composite material, laminate or article of claim 1 and separating the gas from the mixture by contacting the mixture and the composite material, laminate or article.

25. The method of claim 24, wherein the gas is carbon dioxide.

26. A method of forming a composite material, the method comprising:
(a) dissolving a solid poly(ionic liquid)s polymer in a solvent to form a poly(ionic liquid)s polymer solution;
(b) applying the poly(ionic liquid)s polymer solution to a porous polymer membrane having a void volume providing pores and a microstructure of nodes interconnected by fibrils or only fibrils; and
(c) removing the solvent after applying the poly(ionic liquid)s polymer solution to the porous polymer membrane, and
(d) expanding the composite material after step (b) and/or after step (c) wherein the poly(ionic liquid)s polymer is partially or fully imbibed into the void volume of the microstructure of the porous polymer membrane.

27.-28. (canceled)

29. The method of claim 26, further comprising (f) compressing the composite material after step (b), step (c), and/or step (d).

30. A method to form a composite material comprising:
(a) providing
(i) a poly(ionic liquid)s polymer solution; and
(ii) an expanded porous membrane having a first side and a second side;
where the expanded porous membrane has a void volume providing pores and a microstructure of fibrils, and optionally nodes interconnecting the fibrils; and
(b) depositing the poly(ionic liquid)s polymer solution on at least one side of the expanded porous membrane whereby the composite material is formed;
(c) optionally subjecting the composite material of step (b) to one or more steps of heating, stretching, compacting or any combination thereof.
